(19) United States
(12) Patent Application Publication
(10) Pub. No.: US 2023/0148042 A1
(43) Pub. Date: May 11, 2023

(54) COMMUNICATION SYSTEM AND COMMUNICATION METHOD

(71) Applicant: Nippon Telegraph and Telephone Corporation, Tokyo (JP)

(72) Inventors: Naoki HANAOKA, Musashino-shi, Tokyo (JP); Hidetoshi TAKADA, Musashino-shi, Tokyo (JP); Toshihiro HAYASHI, Musashino-shi, Tokyo (JP); Masaki KOZAI, Musashino-shi, Tokyo (JP)

(21) Appl. No.: 17/919,641

(22) PCT Filed: May 11, 2020
(86) PCT No.: PCT/JP2020/018842

§ 371 Date: Oct. 18, 2022

(51) Int. Cl. H04B 10/80; H04B 10/272

(52) U.S. Cl. CPC H04B 10/806; H04B 10/272

(57) ABSTRACT

Provided is a communication system including a communication building side communication device in a communication building and a user's home side communication device in a user's home that are connected via an optical fiber and a metal cable. When a power fed to the user's home side communication device from a commercial power supply stops, the communication building side communication device feeds the power to the user's home side communication device via the metal cable to operate the user's home side communication device, and the user's home side communication device communicates with the communication building side communication device via the optical fiber.

### TECHNICAL FIELD

The present invention relates to a technique for enabling continuous communication when a power failure occurs due to disasters or the like.

### BACKGROUND ART

Conventionally, telephone services have been provided via metal cables extending from a communication building to users' homes. The power and the voice communication service can be provided simultaneously to telephones (rotary dial telephones and the like) via the metal cables.

In recent years, the metal cables extending in the whole sections from the communication building to users' homes have been replaced with optical fibers to provide a high-speed data communication service to many users' homes. Connecting the whole sections from the communication building to the user's home via the optical fiber is referred to as Fiber To The Home (FTTH).

### CITATION LIST

### Non-Patent Literature

Non-Patent Literature 1: Media Network Technology (NTT Access Network Service Systems Laboratories), https://www.ansl.ntt.co.jp/history/media/index.html, searched on 24 Apr. 2020

### SUMMARY OF THE INVENTION

### Technical Problem

In order to connect a PC, a telephone, and the like in a user's home to a communication network (IP communication network or the like) via an optical fiber, a user's home side communication device is set in the user's home. The user's home side communication device is also referred to as a home gateway (HGW).

In order for the user's home side communication device to operate, it is necessary to supply the power from the commercial power supply. Therefore, if a disaster occurs and a power failure occurs in the user's home, no power is supplied to the user's home communication device so that the user's home side communication device stops working and cannot be connected to the communication network.

For dealing with such circumstances, it is considered to feed the power to the user's home side communication device from the communication building via the optical fiber. With the current technology, however, it is inefficient to feed the power only via the optical fiber and it is difficult to feed the power in a practical manner.

The present invention is designed in view of the foregoing, and it is an object thereof to provide a technique for properly operating the user's home side communication device even when a power failure occurs on the user's home side due to a disaster.

### Means for Solving the Problem

According to the disclosed technique, provided is a communication system including a communication building side communication device in a communication building and a user's home side communication device in a user's home, the communication building side communication device and the user's home side communication device being connected via an optical fiber and a metal cable, wherein: when a power fed to the user's home side communication device from a commercial power supply stops, the communication building side communication device feeds the power to the user's home side communication device via the metal cable to operate the user's home side communication device; and the user's home side communication device communicates with the communication building side communication device via the optical fiber.

### Effects of the Invention

According to the technique of the present disclosure, the user's home side communication device can be properly operated even when a power failure occurs on the user's home side due to a disaster.

### BRIEF DESCRIPTION OF DRAWINGS

FIG. 1 is a diagram illustrating an example of an overall configuration of a system according to an embodiment of the present invention.

FIG. 2 is a diagram illustrating an example of a configuration of a user's home side communication device.

FIG. 3 is a diagram illustrating an example of a configuration of a communication building side communication device.

FIG. 4 is a flowchart illustrating an operation of the communication building side communication device.

FIG. 5 is a chart illustrating an example of a sequence between a communication building and a user's home.

FIG. 6 is a chart illustrating an example of a sequence between a communication building and a user's home.

FIG. 7 is a chart illustrating an example of a safety check procedure.

FIG. 8 is a diagram illustrating an example of a configuration in a case where SPE is used as a metal cable.

FIG. 9 is a diagram illustrating an example of a configuration of a PON.

FIG. 10 is a diagram illustrating an example of a configuration inside an optical splitter box.

FIG. 11 is a diagram illustrating an example of a hardware configuration of a device.

### DESCRIPTION OF EMBODIMENT

Hereinafter, a mode for embodying the present invention (embodiment) will be described with reference to the accompanying drawings. The embodiment described hereinafter is an example only, and embodiments to which the present invention is applied are not limited to the embodiment described hereinafter.

(Overall Configuration)

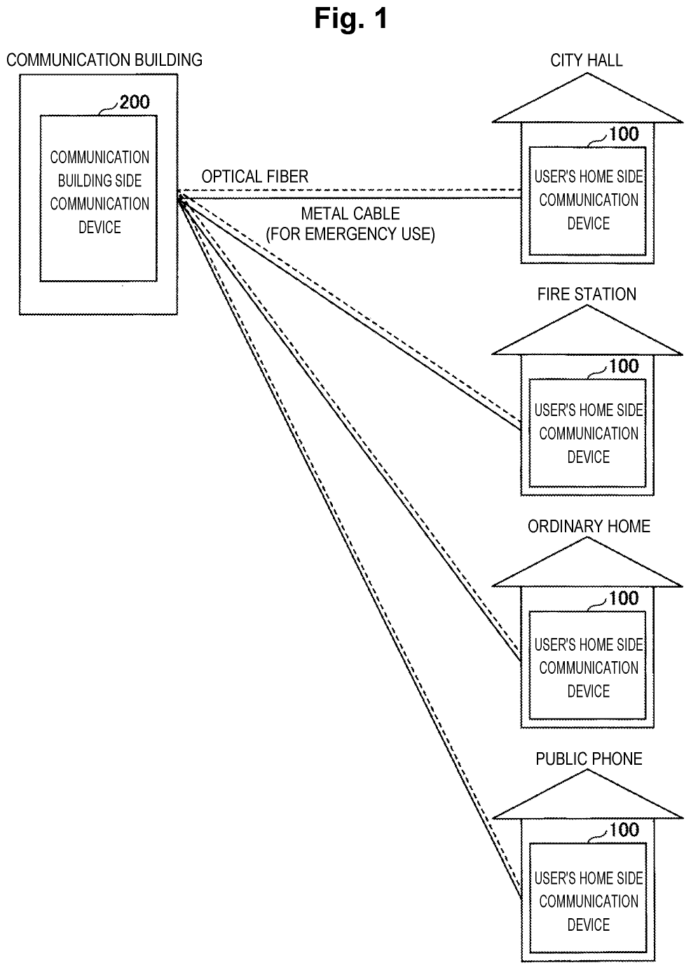

FIG. 1 illustrates an example of an overall configuration of a system according to an embodiment of the present invention. In the example of FIG. 1, “city hall”, “fire station”, “ordinary home”, and “public phone” are illustrated as examples of a user's home. Each user's home is connected to a communication building via an optical fiber and a metal cable.

While FIG. 1 illustrates a star configuration in which a pair of “optical fiber and metal cable” extends from the communication building to each user's home, such a configuration is simply an example. Other than the star configuration, a bus configuration and a tree configuration are also possible.

A pair of “optical fiber and metal cable” may be a composite cable in which an optical fiber and a metal cable are formed as a single cable, or the optical fiber and the metal cable may be independent from each other.

As illustrated in FIG. 1, a communication building side communication device 200 is provided in the communication building, and a user's home side communication device 100 is provided in each user's home. The communication building side communication device 200 is a device that terminates the optical fiber and the metal cable extending from the user's home and is connected to a higher communication network. The user's home side communication device 100 is a device that terminates the optical fiber and the metal cable extending from the communication building and connects the PC, telephones, and the like in the user's home to a communication network via the optical fiber.

In the embodiment, when a power failure occurs in the user's home under a disaster and the power cannot be fed to the user's home side communication device 100 from the commercial power supply, the power is fed to the user's home side communication device 100 from the communication building side communication device 200 via the metal cable to activate the user's home side communication device 100 so as to continue communication via the optical fiber.

In the embodiment, in order to allow the user's home side communication device 100 of large power consumption to operate normally, the power is fed via the metal cable with a voltage of 380 V that is higher than a voltage (60 V) of Safety Extra-Low Voltage (SELV). Note that “380 V” is an example, and the power may be fed with a voltage that is higher than this voltage or the power may be fed with a voltage lower than this voltage.

Furthermore, since the power is fed with a high voltage exceeding the voltage of SELV in the embodiment, the power is fed after checking the normality (safety) of the metal cable, the connection part (connector), and the like in order to secure the safety. As the normality check procedure, it is possible to use the procedure same as the charging procedure under CHAdeMO protocol, for example.

(Example of Device Configuration)

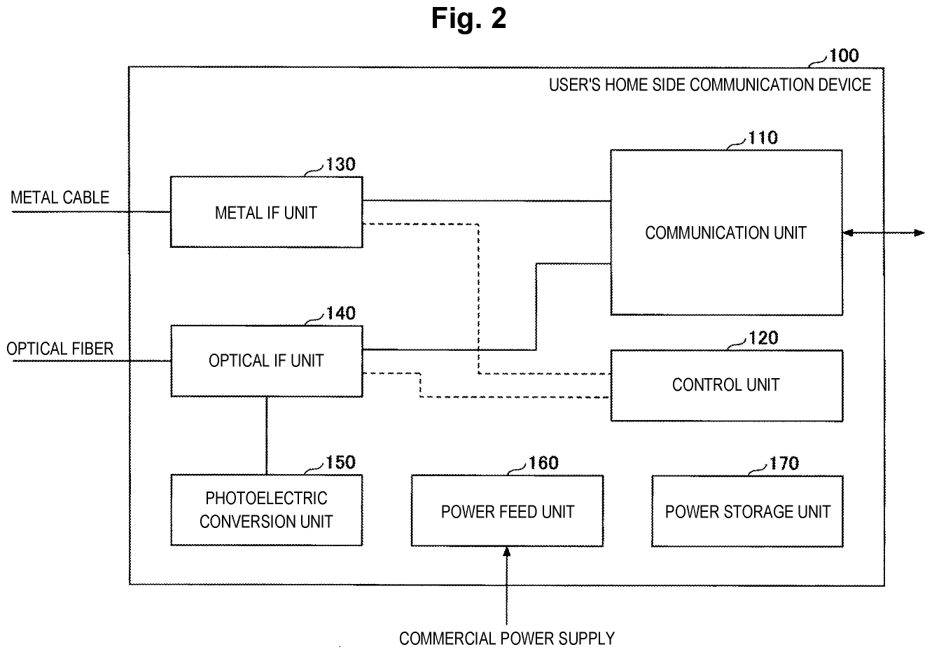

FIG. 2 illustrates an example of the configuration of the user's home side communication device 100. As illustrated in FIG. 2, the user's home side communication device 100 includes a communication unit 110, a control unit 120, a metal IF unit 130, an optical IF unit 140, a photoelectric conversion unit 150, a power feed unit 160, and a power storage unit 170. Note that either one of or both of the photoelectric conversion unit 150 and the power storage unit 170 may not necessarily be provided. Furthermore, the metal IF unit 130 and the optical IF unit 140 may be referred to as a metal line termination unit and an optical network unit, respectively.

The communication unit 110 includes a router, a wireless LAN adapter, a telephone adapter, and the like, and provides a communication service to the PC and the telephone connected to the user's home side communication device 100 in the user's home.

The control unit 120 controls the user's home side communication device 100. In particular, in the embodiment, executed in cooperation with the communication building side communication device 200 under a power failure are the state check, the normality check, and the like.

The metal IF unit 130 is physically connected to the metal cable, transmits signals received from the metal cable to the communication unit 110 or the control unit 120, and sends out signals received from the communication unit 110 or the control unit 120 to the metal cable. Furthermore, the metal IF unit 130 receives the power supplied from the communication building side communication device 200, and feeds the power to each unit of the user's home side communication device 100.

The optical IF unit 140 is physically connected to the optical fiber, and converts optical signals received from the optical fiber to electric signals and transmits the electric signals to the communication unit 110 or the control unit 120. Furthermore, the optical IF unit 140 converts electric signals received from the communication unit 110 or the control unit 120 to optical signals and sends out the optical signals to the optical fiber.

The photoelectric conversion unit 150 converts the optical energy received from the optical fiber into the power, and feeds that power to each unit of the user's home side communication device 100. The power feed unit 160 receives the power from the commercial power supply via an AC adapter or the like, and feeds the received power to each unit of the user's home side communication device 100. The power storage unit 170 receives the power from the power feed unit 160 and the like and stores the power. The power storage unit 170 discharges the power as necessary such as when the power from the commercial power supply is stopped to feed the power to each unit of the user's home side communication device 100.

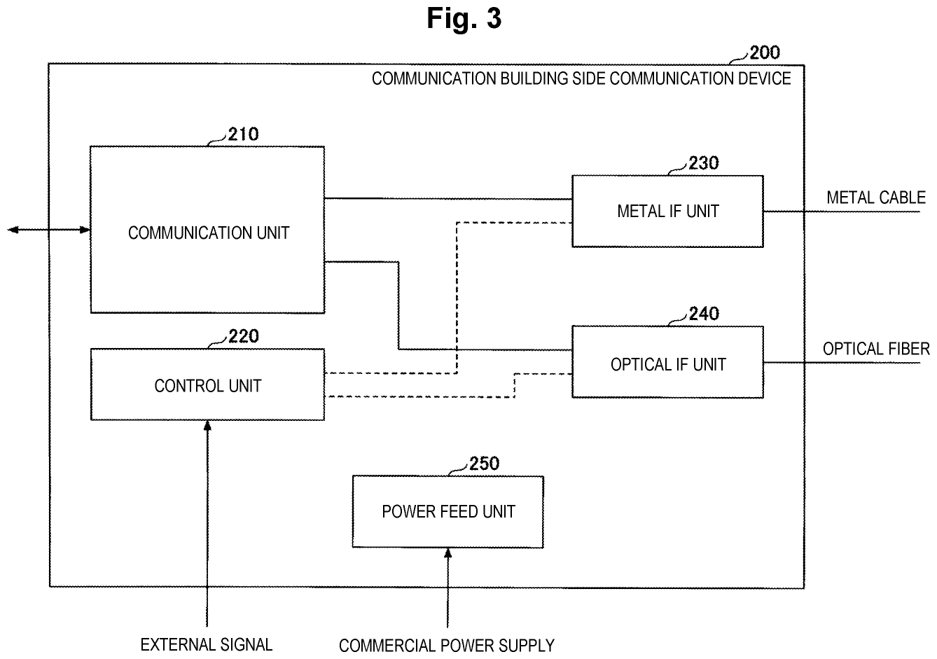

FIG. 3 illustrates an example of the configuration of the communication building side communication device 200. Note that the communication building side communication device 200 illustrated in FIG. 3 may be a communication building side communication device 200 that accommodates a single user's home side communication device 100 or may be a communication building side communication device 200 that accommodates a plurality of user's home side communication devices 100. For the sake of simplifying explanations, it is assumed herein that the communication building side communication device 200 illustrated in FIG. 3 is a communication building side communication device 200 that accommodates a single user's home side communication device 100.

As illustrated in FIG. 3, the station communication device 200 includes a communication unit 210, a control unit 220, a metal IF unit 230, an optical IF unit 240, and a power feed unit 250. Furthermore, the metal IF unit 230 and the optical IF unit 240 may be referred to as a metal line termination unit and an optical network unit, respectively.

The communication unit 210 is a function unit that includes a router and the like, and enables the higher communication network and the user's home side communication device 100 to have packet communication. The control unit 220 controls the communication building side communication device 200. In particular, in the embodiment, executed at the time of a power failure occurring in the user's home are the state check, the normality check, and the like of the user's home side communication device 100. Furthermore, the control unit 220 also has a function of receiving external signals such as J-alert, and comprehending the content thereof.

The metal IF unit 230 is physically connected to the metal cable, transmits signals received from the metal cable to the communication unit 210 or the control unit 220, and sends out signals received from the communication unit 210 or the control unit 220 to the metal cable. Furthermore, the metal IF unit 230 feeds the power from the power feed unit 250 to the user's home side communication device 100.

The optical IF unit 240 is physically connected to the optical fiber, and converts optical signals received from the optical fiber to electric signals and transmits the electric signals to the communication unit 210 or the control unit 220. Furthermore, the optical IF unit 240 converts electric signals received from the communication unit 210 or the control unit 220 to optical signals and sends out the optical signals to the optical fiber. The power feed unit 250 receives the power from the commercial power supply via an AC adapter, and feeds the received power to each unit of the communication building side communication device 200.

(Operation Example of Communication Building Side Communication Device 200)

When a power failure occurs on the user's home side, the properly operating communication building side communication device 200 executes the normality check and the like of the optical fiber and the metal cable connected to the user's home side communication device 100 and feeds the power to the user's home side communication device 100 via the metal cable so as to properly operate the user's home side communication device 100 even under the power failure.

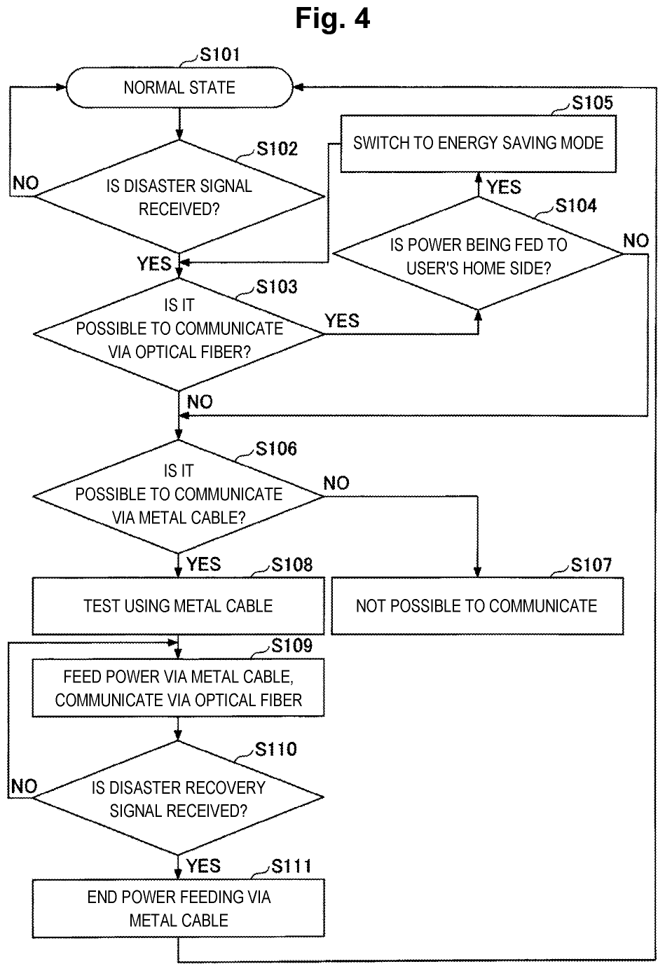

FIG. 4 is a flowchart illustrating an operation example of the communication building side communication device 200. In S101, the user's home side communication device 100 is in a normal state and communicating with the communication building side communication device 200 via the optical fiber.

In S102, the control unit 220 of the communication building side communication device 200 determines whether a disaster signal is received. The disaster signal is a J-alert, for example. The disaster signal may be input to the control unit 220 automatically from the system that transmits the disaster signals or may be input manually by those who have detected the disaster signal.

Upon receiving the disaster signal (Yes in S102), the control unit 220 determines whether it is possible to communicate via the optical fiber in S103. This can be determined based on whether there is a response signal from the user's home side communication device 100 when the control unit 220 transmits a test signal to the user's home side communication device 100 from the optical IF unit 240, for example.

When it is possible to communicate via the optical fiber (Yes in S103), the control unit 220 determines whether the power is being fed to the user's home side communication device 100 in S104. It is assumed herein that the control unit 220 is capable of acquiring information regarding whether the power is being fed and information regarding the state (charged amount and the like) of the power storage unit 170 from the user's home side communication device 100 via the optical fiber, so that it is possible to determine whether the power is being fed based thereupon.

When the power is being fed (Yes in S104), the control unit 220 transmits a control signal to the user's home side communication device 100 to switch the user's home side communication device 100 to an energy saving mode in S105. The user's home side communication device 100 continues communication in the energy saving mode. It is assumed herein that the power is being fed by the power storage unit 170, so that the energy saving mode is selected. After switching to the energy saving mode, the processing is returned to S103.

When it is not possible to communicate via the optical fiber (No in S103) or the power is not being fed to the user's home side communication device 100 (No in S104), the control unit 220 determines whether it is possible to communicate via the metal cable in S106. This can be determined based on whether there is a response signal from the user's home side communication device 100 when the control unit 220 transmits minute power necessary for activating the user's home side communication device 100 and an activation signal from the metal IF unit 230, for example. For the activation by the metal cable herein, a voltage of 48 V is used, for example.

When it is not possible to communicate via the metal cable (No in S106), it is not possible to communicate (S107) and the processing for the user's home side communication device 100 is ended. In this case, there is a possibility that the metal cable may be disconnected.

When it is possible to communicate via the metal cable (Yes in S106), the control unit 220 executes a test for the normality check (safety check) using the metal cable in S108. Examples of the test may be an insulation resistance measurement, a leakage current test, a connector lock check, and the like.

In the test performed in S108, the test such as application of the voltage and current may be performed on the metal cable, and signal transmission/reception for notification and the like of the state (voltage value, current value, resistance value, and the like) may be performed on the optical fiber. It is because the power is fed via the metal cable so that it becomes possible at this point to communicate via the optical fiber.

Furthermore, in the test performed in S108, both application and the like of the voltage and current and signal transmission/reception may be performed on the metal cable. This is possible since power feeding and communication can be simultaneously performed by using the cable of Single Pair Ethernet (R) to be described later as the metal cable. It is assumed herein that the test is successful.

In S109, the control unit 220 instructs the metal IF unit 230 to feed the power to the user's home communication device 100 from the metal IF unit 230 via the metal cable. Herein, the power is fed with a high voltage of 380 V or the like described above, for example. Since the user's home side communication device 100 operates normally by the power fed via the metal cable, it is possible to perform communication via the optical fiber as with in the communication state of S101.

In S110, the control unit 220 determines whether a disaster recovery signal is received. Note that receiving the disaster recovery signal herein means that the power failure occurred in the user's home is restored. The disaster recovery signal may be input to the control unit 220 automatically or manually. When no disaster recovery signal is received (No in S110), the processing is returned to S109 and power feeding via the metal cable is continued.

When the disaster recovery signal is received (Yes in S110), power feeding via the metal cable is ended in S111 and the power feeding is to be shifted to the normal state (S101).

### Example of Sequence

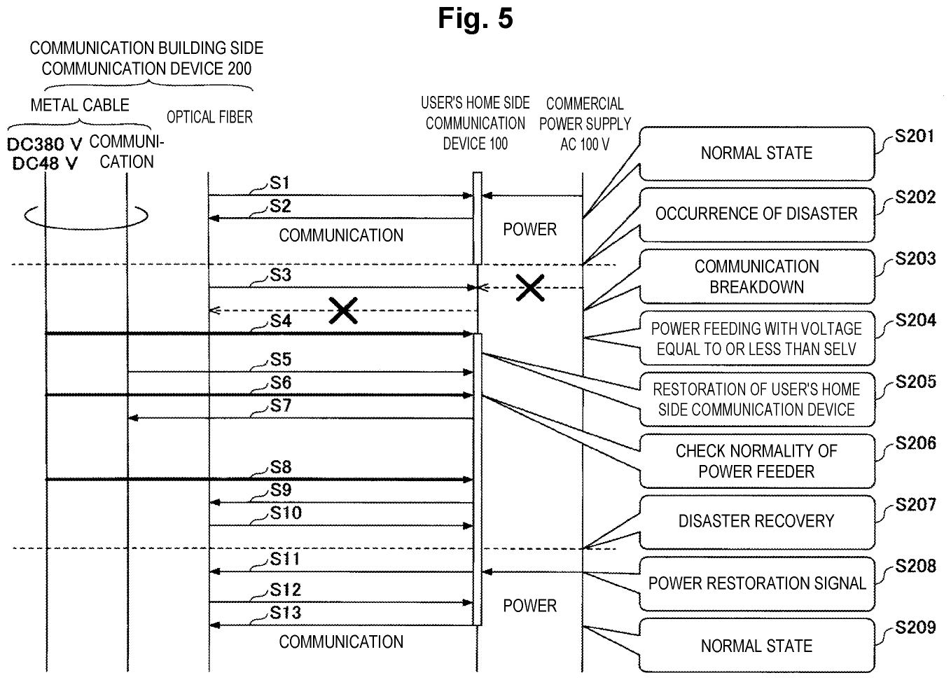

Next, an example of a sequence between the communication building side communication device 200 and the user's home side communication device 100 will be described by referring to FIG. 5.

In a normal state (S201), the power is fed to the user's home communication device 100 from the commercial power supply (AC 100 V), and communication is performed properly between the communication building side communication device 200 and the user's home side communication device 100 (S1, S2).

When a disaster occurs (S202), the power fed from the commercial power supply to the user's home side communication device 100 stops. Therefore, even though the optical signal (S3) from the communication building side communication device 200 reaches the user's home side communication device 100, the user's home side communication device 100 cannot transmit the optical signal.

The communication building side communication device 200 upon detecting occurrence of a disaster feeds the power to the user's home side communication device 100 via the metal cable using a voltage (for example, 48 V) that is equal to or less than SELV (S4) to activate the user's home side communication device 100 (S204, S205). Furthermore, the communication building side communication device 200 performs the normality check (including safety check) of the metal cable in order to check whether it is possible to feed the power with a high voltage (for example, 380 V) (S5 to S7, S206).

When the normality is confirmed, the communication building side communication device 200 feeds the power to the user's home side communication device 100 with a high voltage (for example, 380 V) (S8). Thereby, the user's home side communication device 100 can operate in a normal state and perform communication via the optical fiber (S9, S10).

When the disaster is over and the power is restored (S207), a power restoration signal is transmitted from the user's home side communication device 100 to the communication building side communication device 200 (S208, S11). Thereafter, power feeding via the metal cable is stopped, and communication via the optical fiber is performed as in a normal state (S12, S13, S209).

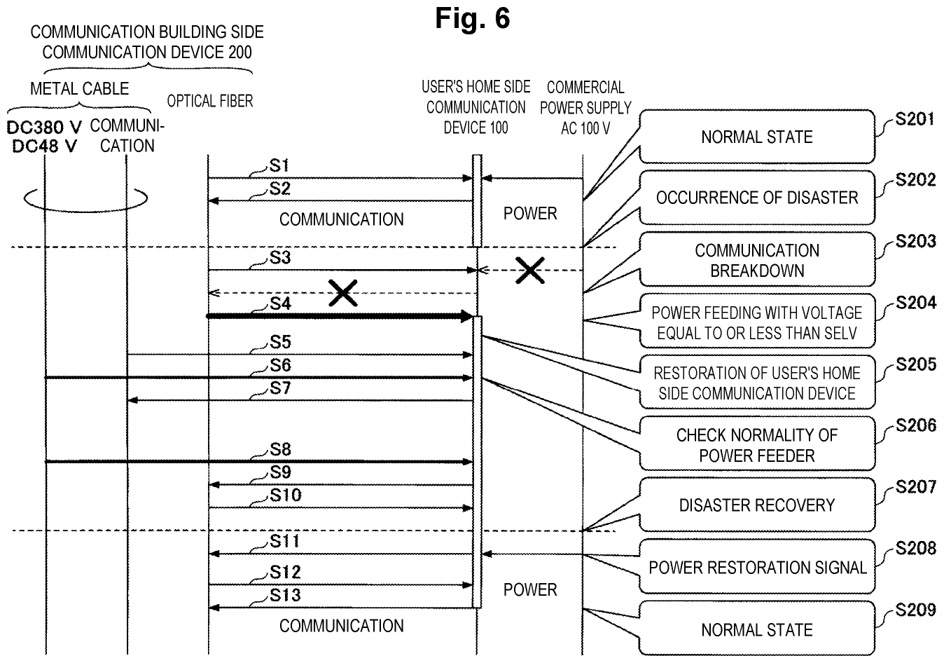

While the power is fed with 48 V via the metal cable in the example illustrated in FIG. 5 in order to activate the user's home side communication device 100 that has stopped due to the power failure, the power may be fed via the optical fiber for this activation. FIG. 6 illustrates an example of such a case. In the example of FIG. 6, the power is fed to the user's home communication device 100 via the optical fiber in S4.

In the example of FIG. 5, it is necessary for the communication building side communication device 200 to switch the voltage of the power fed to the user's home communication device 100 via the metal cable from 48 V to 380 V. However, in the example of FIG. 6, it is not necessary to do so, and it is possible to use only the power feed unit for feeding the power of 380 V.

### Example of Normality Check Procedure

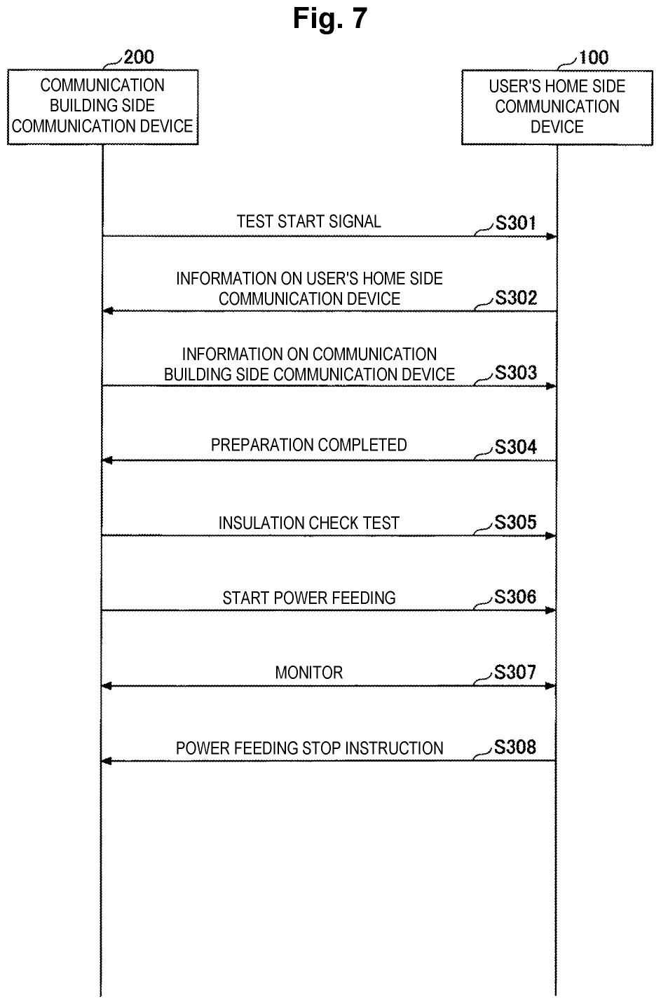

Referring to FIG. 7, an example of the normality check procedure performed on the metal cable will be described. While the test is executed only on the metal cable in the example of FIG. 7, power feeding (application and the like of the power and current) may be performed on the metal cable and signal transmission/reception may be performed on the optical fiber. Furthermore, the following processing is a processing that is executed mainly between the control unit 220 of the communication building side communication device 200 and the control unit 120 of the user's home side communication device 100.

In S301, the communication building side communication device 200 transmits a test start signal to the user's home side communication device 100. In S302, the user's home side communication device 100 transmits the information (for example, the maximum allowable voltage and the like) on the user's home side communication device 100 to the communication building side communication device 200. In S303, the communication building side communication device 200 transmits the information on the communication building side communication device 200 to the user's home side communication device 100.

In S304, the user's home side communication device 100 transmits the information indicating that preparation for receiving the fed power is completed to the communication building side communication device 200.

In S305, the communication building side communication device 200 performs an insulation check test by applying the voltage to the metal cable. When no problem is found in the insulation check test, the communication building side communication device 200 starts to feed the power to the user's home side control device 100 in S306.

In S307, the user's home side communication device 100 monitors the voltage and the current of the fed power and, when there is any problem, notifies it to the communication building side communication device 200, and the communication building side communication device 200 stops feeding the power. Furthermore, the communication building side communication device 200 also monitors the voltage and the current of the power to be fed, and stops feeding the power when there is any problem in insulation properties or the like. This makes it possible to secure the safety of the user.

When the power fed from the commercial power supply is restored in the user's home side communication device 100, the user's home side communication device 100 transmits a power feeding stop instruction to the communication building side communication device 200 in S308.

### Example of Using Single Pair Ethernet®

While any kinds of metal cables may be used as the metal cable according to the embodiment, a cable of Single Pair Ethernet® (referred to as SPE hereinafter) can be used, for example. Since communication and power feeding can be performed simultaneously with the SPE, the safety check of the metal cable (power feeder) can be performed promptly without using the optical fiber.

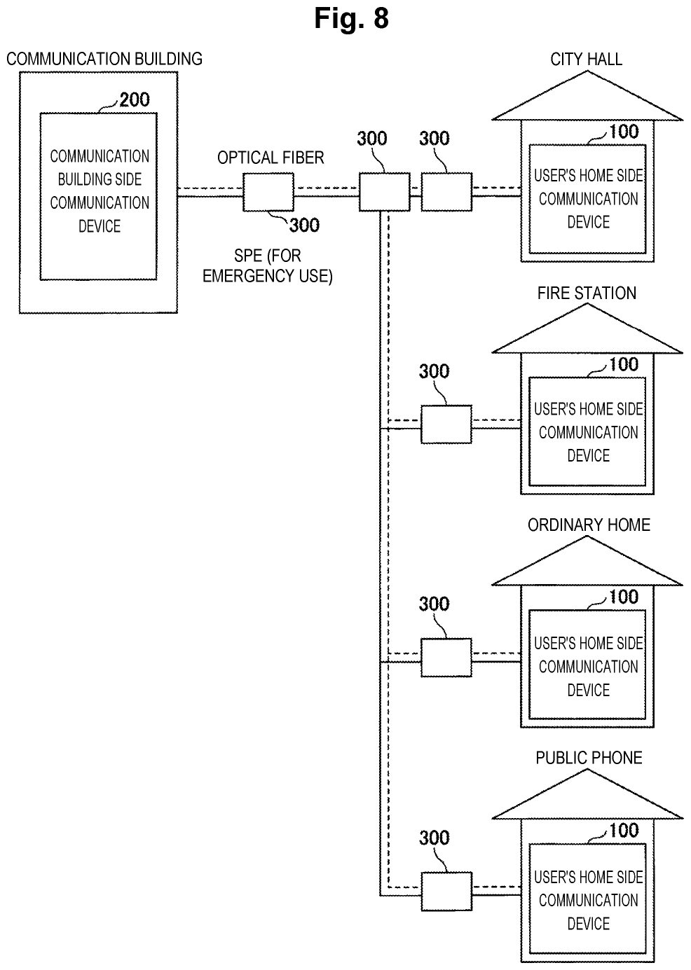

FIG. 8 illustrates an example of an overall configuration of a communication system in a case of using the SPE as the metal cable. The length of the SPE with which communication and power feeding can be simultaneously performed is up to 1 km. Therefore, when the length of the cable from the communication building side communication device 200 to the user's home side control device 100 exceeds 1 km, a relay point is provided to connect the SPE. In FIG. 8, such relay points 300 are illustrated.

(Application to PON)

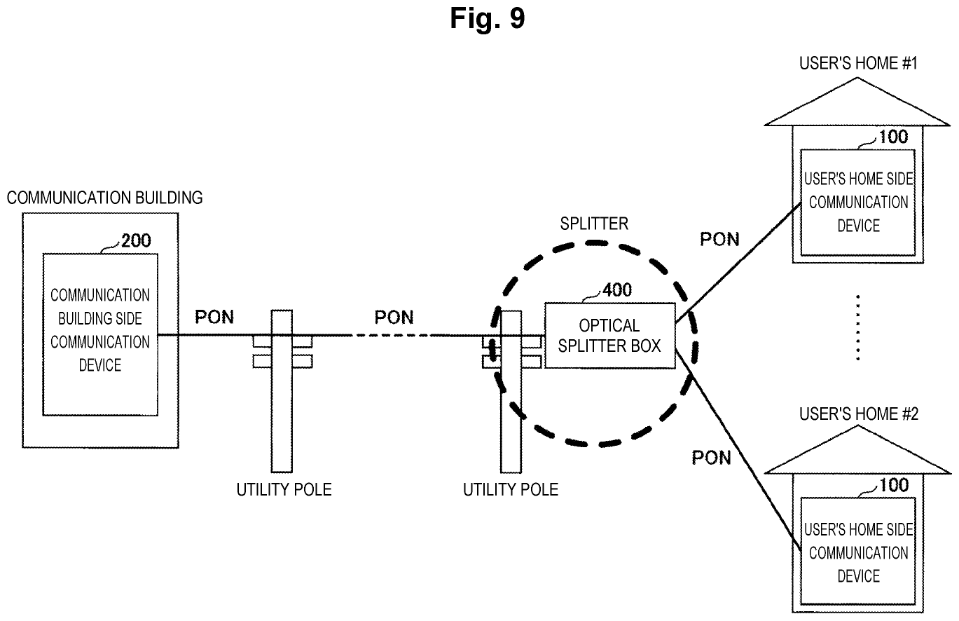

The technology that uses the metal cable as an emergency power feeder in a communication network where communication is performed via the optical fiber can also be applied to a Passive Optical Network (PON). FIG. 9 illustrates an example of the configuration of the PON. With the PON, a splitter as a passive element is used to split an optical signal from the communication building to a plurality of signals and the optical fiber from the communication building to the splitter is shared by a plurality of users' homes to achieve a cost-effective network. The splitter is provided within an optical splitter box 400 illustrated in FIG. 9.

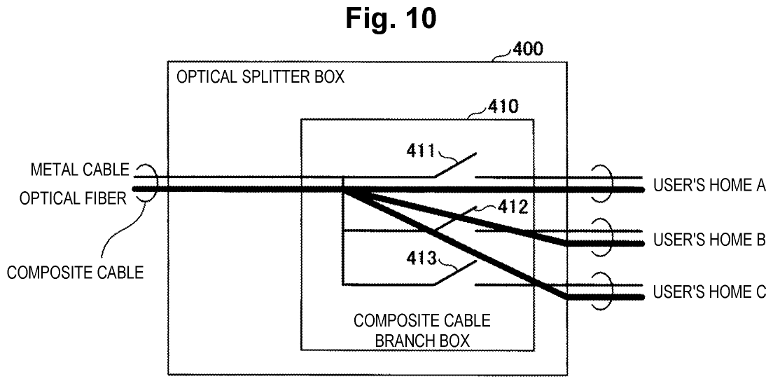

FIG. 10 illustrates an example of an internal configuration of the optical splitter box according to the embodiment that uses the optical fiber and the metal cable. In the example illustrated in FIG. 10, the optical fiber and the metal cable are formed into a single cable as a composite cable. The optical fiber and the metal cable are separated within a composite cable branch box 410 inside the optical splitter box 400, and the optical fiber is branched for a plurality of users' homes by the splitter.

The metal cable is also branched for the plurality of users' homes, and switches 411, 412, and 413 are provided to each of the branched metal cables. The switches are semiconductor switches, for example, and the control unit 220 of the communication building side communication device 200 can control ON/OFF thereof.

For example, provided that there are a user's home A, a user's home B, and a user's home C as illustrated in FIG. 10, it is assumed that there are a user's home side communication device 100A, a user's home side communication device 100B, and a user's home side communication device 100C provided in the respective homes.

It is assumed that a disaster occurs and a power failure occurs in the user's home A, the user's home B, and the user's home C. In that case, basically, a flow illustrated in FIG. 4 is executed for each of the user's home side communication device 100A, the user's home side communication device 100B, and the user's home side communication device 100C.

In particular, S106 (check whether it is possible to communicate via the metal cable, activation of the user's home side communication device 100) and S108 (normality check test of the metal cable) are performed by turning ON only the switch for the target user's home. For example, when the communication building side communication device 200 checks the metal cable for the user's home side communication device 100A, the communication building side communication device 200 turns ON the switch 411 (turns OFF the switches 412 and 413) to perform the normality check of the metal cable for the user's home side communication device 100A. Then, the communication building side communication device 200 turns ON the switch 412 (turns OFF the switches 411 and 413) to perform the normality check of the metal cable for the user's home side communication device 100B. At last, the communication building side communication device 200 turns ON the switch 413 (turns OFF the switches 411 and 412) to perform the normality check of the metal cable for the user's home side communication device 100C.

When the normality check of the entire metal cables for the user's home side communication device 100A, the user's home side communication device 100B, and the user's home side communication device 100C is OK, all switches are turned ON to start to feed the power to the user's home side communication device 100A, the user's home side communication device 100B, and the user's home side communication device 100C. Thereby, even during a disaster, the user's home side communication device 100A, the user's home side communication device 100B, and the user's home side communication device 100C can perform optical fiber communication by the PON as with in a normal state.

In a case where the normality check of the metal cables for the user's home side communication device 100A and the user's home side communication device 100B is OK but the normality check of the metal cable for the user's home side communication device 100C is NG, for example, the switch 411 and the switch 412 are turned ON and the switch 413 is turned OFF to start to feed the power.

(Example of Hardware Configuration)

Each of the user's home side communication device 100 and the station home side communication device 200 may not necessarily be a single device physically but may be configured by connecting a plurality of devices in a network. For example, each of the control unit 120 of the user's home side communication device 100 and the control unit 220 of the station home side communication device 200 may be implemented by causing a computer, for example, to execute a program in which the processing content described in the embodiment is written.

The above-described program can be recorded on a computer-readable recording medium (portable memory or the like) to be saved and distributed. Furthermore, the above-described program can be provided through a network such as the Internet or an e-mail.

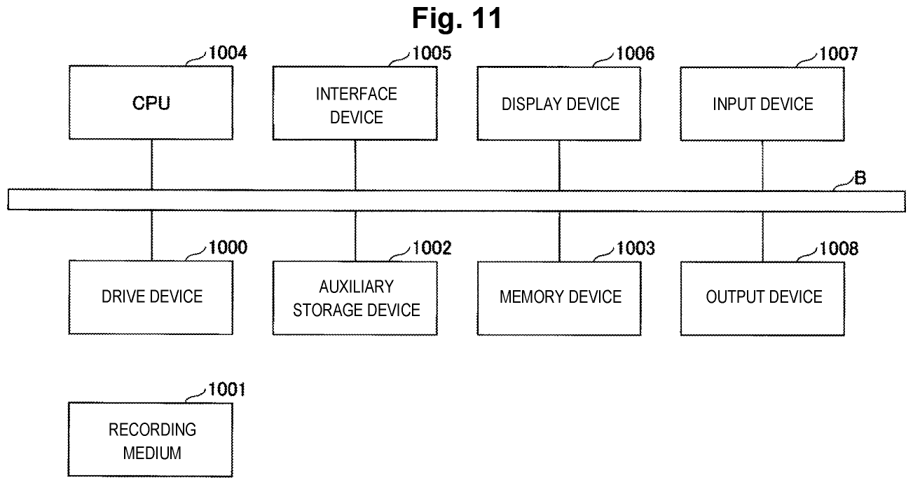

FIG. 11 is a diagram illustrating an example of the hardware configuration of the above-described computer. The computer of FIG. 11 includes a drive device 1000, an auxiliary storage device 1002, a memory device 1003, a CPU 1004, an interface device 1005, a display device 1006, an input device 1007, an output device 1008, and the like, which are mutually connected via a bus BS.

The program implementing the processing by the above-mentioned computer is provided by a recording medium 1001 such as a CD-ROM or a memory card, for example. When the recording medium 1001 to which the program is stored is set to the drive device 1000, the program is installed to the auxiliary storage device 1002 from the recording medium 1001 via the drive device 1000. Note that, however, the program may not necessarily be installed via the recording medium 1001 but may be downloaded from another computer via a network. The auxiliary storage device 1002 stores the installed program and also stores necessary files, data, and the like.

The memory device 1003 reads out and stores the program from the auxiliary storage device 1002, when there is an instruction to start the program. The CPU 1004 implements a function related to the control units (120, 220) according to the program stored in the memory device 1003. The interface device 1005 is used as an interface for being connected to the network. The display device 1006 displays Graphical User Interface (GUI) and the like by the program. The input device 1007 is configured with a keyboard, a mouse, buttons, a touch panel, or the like, and used to input various operation instructions. The output device 1008 outputs the results of arithmetic operations.

### Effects of Embodiment

According to the technique related to the embodiment, it is possible to properly operate the user's home side communication device and continue communication via the optical fiber even when a power failure occurs on the user's home side due to a disaster.

### Summary of Embodiment

The communication system and the communication method described at least in each of the following supplementary items are described in the present Description.

### (Item 1)

A communication system including a communication building side communication device in a communication building and a user's home side communication device in a user's home, the communication building side communication device and the user's home side communication device being connected via an optical fiber and a metal cable, wherein: when a power fed to the user's home side communication device from a commercial power supply stops, the communication building side communication device feeds the power to the user's home side communication device via the metal cable to operate the user's home side communication device; and the user's home side communication device communicates with the communication building side communication device via the optical fiber.

### (Item 2)

The communication system according to item 1, wherein the communication building side communication device performs safety check of the metal cable before feeding the power to the user's home side communication device.

### (Item 3)

The communication system according to item 1 or 2, wherein, upon receiving a disaster signal, the communication building side communication device feeds the power to the user's home side communication device.

### (Item 4)

The communication system according to any one of items 1 to 3, wherein the communication building side communication device feeds the power to the user's home side communication device with a voltage exceeding a voltage of SELV.

### (Item 5)

The communication system according to any one of items 1 to 4, wherein: a PON is configured with the optical fiber; the optical fiber is branched to a plurality of optical fibers and the metal cable is branched to a plurality of metal cables by an optical splitter box in the PON; and a switch is provided to each of the branched metal cables.

### (Item 6)

A communication method for a communication system including a communication building side communication device in a communication building and a user's home side communication device in a user's home, the communication building side communication device and the user's home side communication device being connected via an optical fiber and a metal cable, the communication method including: when a power fed to the user's home side communication device from a commercial power supply stops, feeding the power to the user's home side communication device from the communication building side communication device via the metal cable to operate the user's home side communication device for allowing the user's home side communication device to communicate with the communication building side communication device via the optical fiber.

While the embodiment has been described heretofore, the present invention is not limited to the specific embodiment but various modifications and changes are possible within the scope of the present invention described in the claims.

### REFERENCE SIGNS LIST

100 User's home side communication device
110 Communication unit
120 Control unit
130 Metal IF unit
140 Optical IF unit
150 Photoelectric conversion unit
160 Power feed unit
170 Power storage unit
200 Communication building side communication
device
210 Communication unit
220 Control unit
230 Metal IF unit
240 Optical IF unit
250 Power feed unit
300 Relay point
400 Optical splitter box
410 Composite cable branch box
411 to 413 Switch
1000 Drive device
1001 Recording medium
1002 Auxiliary storage device
1003 Memory device
1004 CPU
1005 Interface device
1006 Display device
1007 Input device
1008 Output device

1. A communication system comprising a communication building side communication device in a communication building and a user's home side communication device in a user's home, the communication building side communication device and the user's home side communication device being connected via an optical fiber and a metal cable, wherein:
when a power fed to the user's home side communication device from a commercial power supply stops, the communication building side communication device is configured to feed the power to the user's home side communication device via the metal cable to operate the user's home side communication device; and
the user's home side communication device is configured to communicate with the communication building side communication device via the optical fiber.

2. The communication system according to claim 1, wherein the communication building side communication device is configured to perform safety check of the metal cable before feeding the power to the user's home side communication device.

3. The communication system according to claim 1, wherein, upon receiving a disaster signal, the communication building side communication device is configured to feed the power to the user's home side communication device.

4. The communication system according to claim 1, wherein the communication building side communication device is configured to feed the power to the user's home side communication device with a voltage exceeding a voltage of Safety Extra-Low Voltage (SELV).

5. The communication system according to claim 1, wherein:
a PON is configured with the optical fiber; the optical fiber is branched to a plurality of optical fibers and the metal cable is branched to a plurality of metal cables by an optical splitter box in the PON; and a switch is provided to each of the branched metal cables.

6. A communication method for a communication system comprising a communication building side communication device in a communication building and a user's home side communication device in a user's home, the communication building side communication device and the user's home side communication device being connected via an optical fiber and a metal cable, the communication method comprising:
when a power fed to the user's home side communication device from a commercial power supply stops, feeding the power to the user's home side communication device from the communication building side communication device via the metal cable to operate the user's home side communication device for allowing the user's home side communication device to communicate with the communication building side communication device via the optical fiber.

7. The communication system according to claim 2, wherein, upon receiving a disaster signal, the communication building side communication device is configured to feed the power to the user's home side communication device.

8. The communication system according to claim 2, wherein the communication building side communication device is configured to feed the power to the user's home side communication device with a voltage exceeding a voltage of Safety Extra-Low Voltage (SELV).

9. The communication system according to claim 3, wherein the communication building side communication device is configured to feed the power to the user's home side communication device with a voltage exceeding a voltage of Safety Extra-Low Voltage (SELV).

10. The communication system according to claim 2, wherein:
a PON is configured with the optical fiber; the optical fiber is branched to a plurality of optical fibers and the metal cable is branched to a plurality of metal cables by an optical splitter box in the PON; and a switch is provided to each of the branched metal cables.

11. The communication system according to claim 3, wherein:
a PON is configured with the optical fiber; the optical fiber is branched to a plurality of optical fibers and the metal cable is branched to a plurality of metal cables by an optical splitter box in the PON; and a switch is provided to each of the branched metal cables.

12. The communication system according to claim 4, wherein:
a PON is configured with the optical fiber; the optical fiber is branched to a plurality of optical fibers and the metal cable is branched to a plurality of metal cables by an optical splitter box in the PON; and a switch is provided to each of the branched metal cables.
